(19) United States
(12) Patent Application Publication
(10) Pub. No.: US 2013/0243652 A1
(43) Pub. Date: Sep. 19, 2013

(54) AUTOMATIC ANALYZER

(71) Applicants: Kenichi Nishigaki, Mito (JP); Goro Yoshida, Hitachinaka (JP)

(72) Inventors: Kenichi Nishigaki, Mito (JP); Goro Yoshida, Hitachinaka (JP)

(73) Assignee: HITACHI HIGH-TECHNOLOGIES CORPORATION, Tokyo (JP)

(21) Appl. No.: 13/988,812

(22) PCT Filed: Nov. 22, 2011
(86) PCT No.: PCT/JP2011/076879

§ 371 Date: Jun. 5, 2013

(30) Foreign Application Priority Data
Nov. 26, 2010 (JP) 2010-263080

(51) Int. Cl. G01N 35/00

(52) U.S. Cl. CPC G01N 35/00584
USPC 422/68.1

(57) ABSTRACT

With an automatic analyzer for analyzing biological samples, it takes a fairly long time from when the power source of the analyzer is turned on until the analyzer reaches a state stable enough to start analyzing. Thus in order to deal with emergency analysis typically at night, the power source needs to be continuously turned on, which incurs power consumption. Accordingly, power switches are provided which, from among the components configuring the automatic analyzer, turn on and off the power source of the component serving as a heat source for raising the temperature inside the analyzer and the power source of the component as a cold source for lowering the temperature inside the analyzer. A startup mode is selectable corresponding to a temperature rise speed inside the analyzer following an analyzer startup and the on/off operations of the power switch coupled to each of the components is controlled accordingly.

### TECHNICAL FIELD

The present invention relates to an automatic analyzer for clinical tests analyzing biological samples such as blood and urine. More particularly, the invention relates to an automatic analyzer equipped with an automatic startup function.

### BACKGROUND ART

Automatic analyzers for clinical tests have been called on to reduce standby power consumption in order to lower the running cost of the tests and to protect the global environment in general. On the other hand, the automatic analyzers are also required to perform quick diagnoses in response to emergency test requests outside consultation hours for better medical service. To deal with emergency test requests typically at night requires keeping the analyzer in an active state, which does not contribute to reducing power consumption. Thus, the technique described in Patent Document 1 has been proposed as a method for putting the system in the active state before a patient sample arrives at the laboratory.

### PRIOR ART DOCUMENT

### Patent Document

Patent Document 1: JP-2003-121449-A

### SUMMARY OF THE INVENTION

### Problem to be Solved by the Invention

According to the technique described in Patent Document 1, the system can be remotely controlled to shorten its startup time by the amount of the time it takes the user to reach the location where the system is installed. However, since a system startup instruction is issued after a decision is made to test the sample, it still takes the usual time to start up the system following the test request and to reach a level of stability necessary for the analysis.

An object of the present invention is to provide an automatic analyzer capable of dealing with emergency test requests typically at night while reducing power consumption.

### Means for Solving the Problem

In order to achieve the object above, the present invention is configured as follows.

There is provided an automatic analyzer having a reaction vessel for causing a sample to react with a reagent, and a measurement unit for measuring the reaction in the reaction vessel, the automatic analyzer including: power switches which turn on and off a power sources of at least two of components configuring the automatic analyzer, the components including a heat source for raising the temperature inside the analyzer and a cold source for lowering the temperature inside the analyzer; a selection means which selects any of a plurality of startup modes each corresponding to a temperature rise speed inside the analyzer following an analyzer startup; and a control mechanism which, in accordance with the startup mode selected by the selection means, controls the on/off operations of the power switch coupled to each of the components.

The above-mentioned measurement unit may perform, for example, colorimetric analysis (biochemical analysis) whereby the light coming from a light source and passing through a reaction liquid inside the reaction vessel is diffracted into a plurality of wavelengths so that the intensity of the light received at each of the wavelengths may be measured, and chemoluminescence or electrochemical luminescence measurement (immunoassay) involving a photo multiplier or the like measuring the intensity of the light emitted from markers in the reaction liquid. The measurement unit may also measure changes in a physical quantity other than light intensity as long as the measurement involves a reactant. Usually, such a measurement unit has its measured values often varied due to changes in ambient temperature. The present invention is particularly suitable for the measurement unit highly susceptible to the influence of changes in ambient temperature. Among the above-mentioned components, the heat source may be a heater (provided to heat the reaction liquid inside the reaction vessel up to a predetermined temperature), the light source of the measurement unit, a motor for operating a dispensing mechanism dispensing a predetermined amount of a sample or a reagent, or a motor for moving the dispensing mechanism to a predetermined position, for example. In addition to these heat sources, any object that emanates heat to its surroundings when operated in predetermined operation can be a heat source. The cold source may be a cooling mechanism for cooling to a predetermined temperature a reagent vessel that houses reagents so as to prevent deterioration of the reagents therein (although the cooling mechanism can become a heat source if it exchanges heat with the outside in order to cool the reagents, the cooling mechanism remains a cold source when it circulates cooling water that also cools its surroundings), or a cooling fan that lowers the temperature of electronic substrates in the analyzer to below a predetermined temperature, among others. These cooling mechanisms can be cold sources if they have the function of lowering the temperature outside the components.

The plurality of startup modes include an emergency sample measurement mode in which, when a sample urgently needs to be measured at night, the temperature inside the analyzer (especially the temperature of the measurement unit) is raised in the shortest possible time to a level high enough to make measurements stably with the analyzer just started up from its inactivate state, and an energy-saving mode in which a minimum amount of power is used to start up the analyzer. These modes may be set to be effective not only upon analyzer startup but also when the analyzer is stopped but some of its heat sources are kept active to preheat the inside of the analyzer so that the temperature inside the analyzer may later be raised at a higher speed. A variety of startup modes may also be set to address the user's requests. In addition to the startup modes preset by the analyzer manufacturer, a new startup mode may be created by the user utilizing a suitably provided function. In such a case, there may be provided beforehand storage of the thermal dose and cooling dose of each of the components regarded as a heat source or a cold source, and a user interface through which combinations of the stored thermal and cooling doses may be set selectively on a display screen.

### Effects of the Invention

The invention provides an automatic analyzer capable of dealing with emergency test requests typically at night while reducing power consumption.

### BRIEF DESCRIPTION OF THE DRAWINGS

FIG. 1 shows an overall structure of an automatic analyzer for clinical tests.

FIG. 2 shows a structure of the control connections for various objects to be controlled in connection with the present invention. (Embodiment)

FIG. 3 shows a detailed structure of power control for an object to be controlled. (Embodiment)

FIG. 4 shows a detailed scheme of power control for objects to be controlled upon system startup.

FIG. 5 shows effects of power control according to the present invention.

FIG. 6 shows time transitions of control in various startup modes according to the present invention.

### MODE FOR CARRYING OUT THE INVENTION

Some examples of the present invention are explained below in reference to the accompanying drawings.

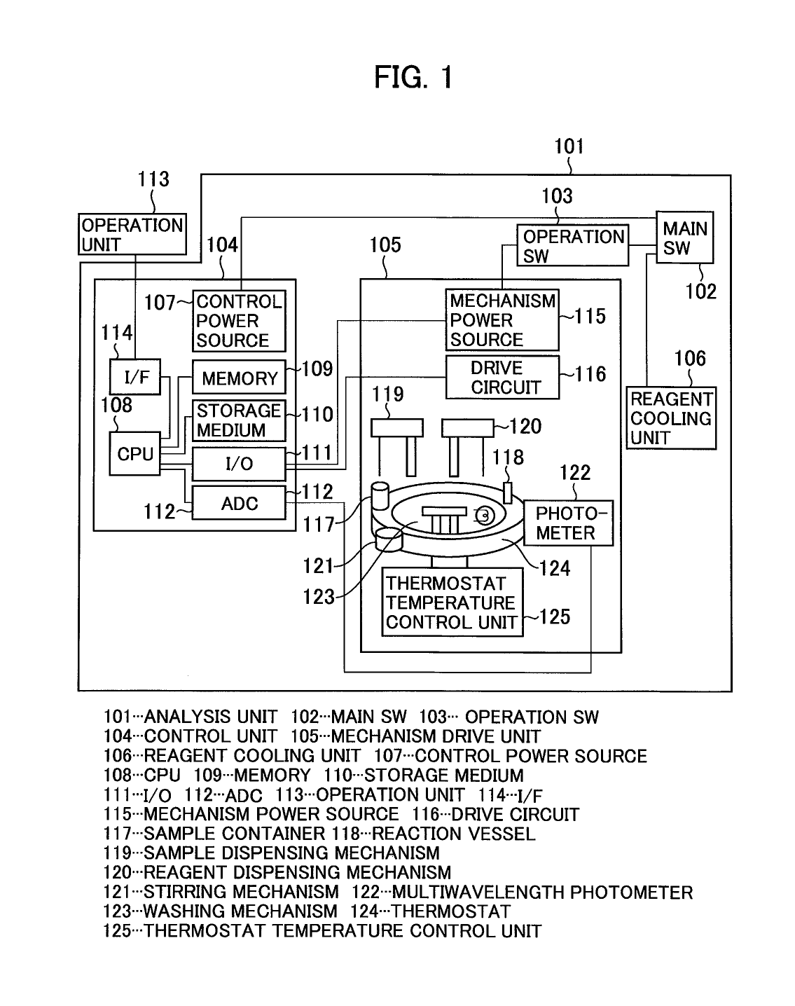

FIG. 1 is an overall block diagram of a biochemical automatic analyzer used in connection with the present invention. An analysis unit 101 is made up of a main SW 102 which is a main switch for receiving power, an operation SW 103 which is a switch for activating the analyzer upon use, a control unit 104, a mechanism drive unit 105, and a reagent cold storage unit 106 for constantly cooling reagents regardless of the state of the operation SW 103.

The control unit 104 is made up of a control power source 107, a CPU 108, a memory 109, a storage medium 110, an I/O unit 111 permitting input and output for controlling the mechanism drive unit 105, an ADC 112 for acquiring measured data through conversion of analog signals into digital form, and an I/F 114 which is an interface portion for communicating with an operation unit 113.

The mechanism drive unit 105 includes a mechanism power source 115, a drive circuit 116, a sample dispensing mechanism 119 for dispensing a sample from a sample container 117 into a reaction vessel 118, a reagent dispensing mechanism 120 for dispensing a reagent into the reaction vessel 118, a stirring mechanism 121 for stirring a liquid mixture in the reaction vessel, a multiwavelength photometer 122 for measuring the absorbance of the liquid mixture, a washing mechanism 123 for washing the reaction vessel after use, a thermostat 124 for keeping a reaction system at a constant temperature so as to stabilize reaction, and a thermostat temperature control unit 125 for controlling the temperature of the thermostat. In the analysis unit 101, the mechanism power source 115 and drive circuit 116 are controlled by signals from the I/O unit 111 of the control unit to drive the mechanisms involved. In the reaction vessel 118, the sample and reagent are mixed to form a liquid mixture. This liquid mixture is subjected to absorbance measurement at the wavelengths corresponding to various analysis items using the multiwavelength photometer 122 and ADC 112, whereby the sample is analyzed.

The reagent cold storage unit 106 keeps reagents at a low temperature for stable analysis operation, and serves as a cooling box for reagents while the analyzer is deactivated and is not operating for analysis. For this reason, the reagent cold storage unit 106 needs to be powered even when the control unit 104 and mechanism drive unit 105 are turned off.

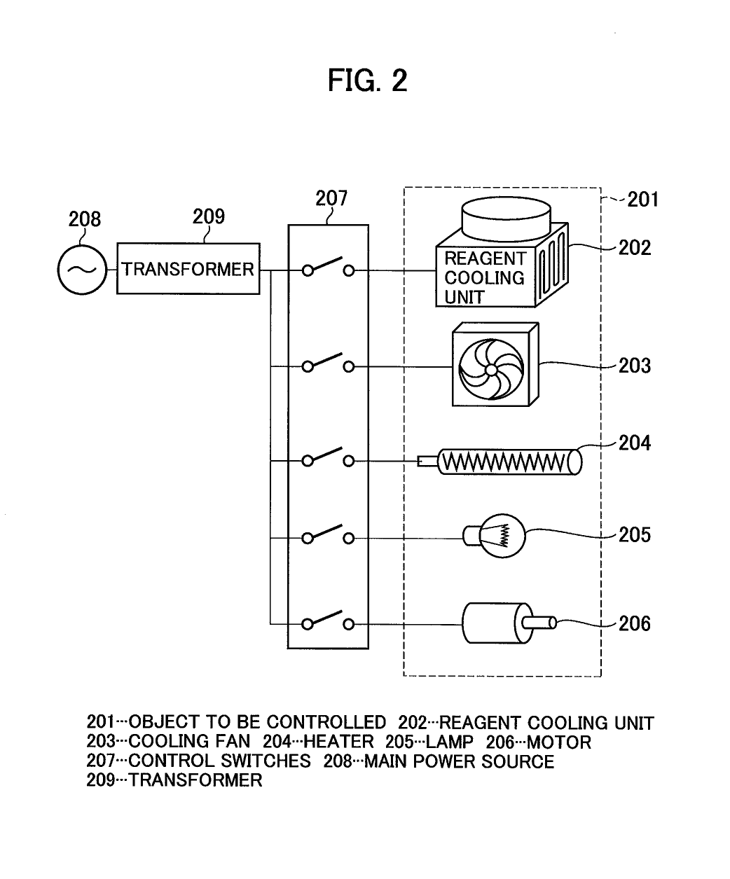

FIG. 2 shows connections of objects to be controlled 201 associated with heat generation in connection with this invention. The objects to be controlled 201 related to heat generation include a reagent cold storage unit 202, a cooling fan 203 for cooling the inside of the analyzer, a heater 204 for heating the thermostat, a lamp 205 acting as the light source of the photometer, and a motor 206 controlled by the drive circuit in the mechanism drive unit. These objects to be controlled are powered by a main power source 208 through an independent control switch 207 that can turn on and off the supply of power by way of a transformer 209.

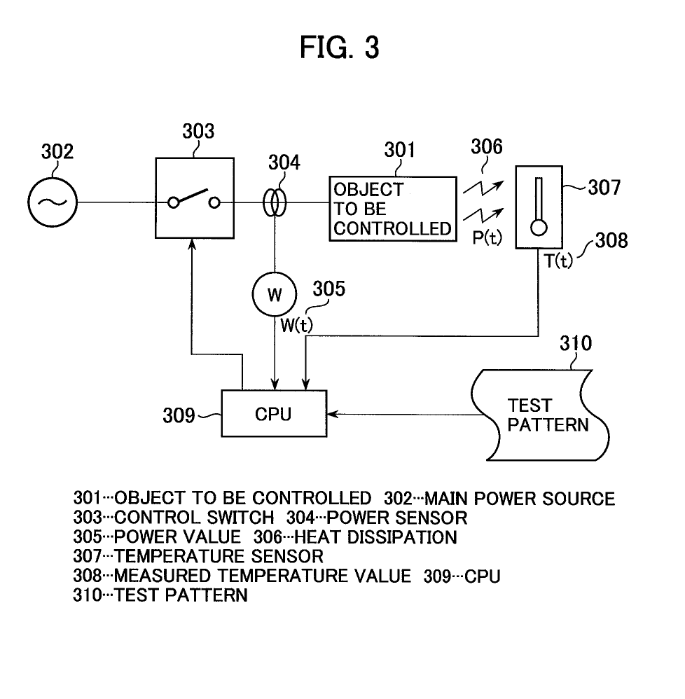

FIG. 3 illustrates a method for connecting and controlling an object to be controlled 301 in connection with the present invention. The power supplied from a main power source 302 and fed to the object to be controlled 301 via a control switch 303 is converted by a power sensor 304 into a power value 305. Heat dissipation 306 from the object to be controlled 301 is captured by a temperature sensor 307 and converted into a measured temperature value 308. Given input of the power value 305 and measured temperature value 308, a CPU 309 gives a command designating the next state of the control switch 303 based on internal control parameters. And as means for automatically preparing the control parameters, the CPU 309 has the function of inputting test patterns 310 that record the combinations of the control switch 303.

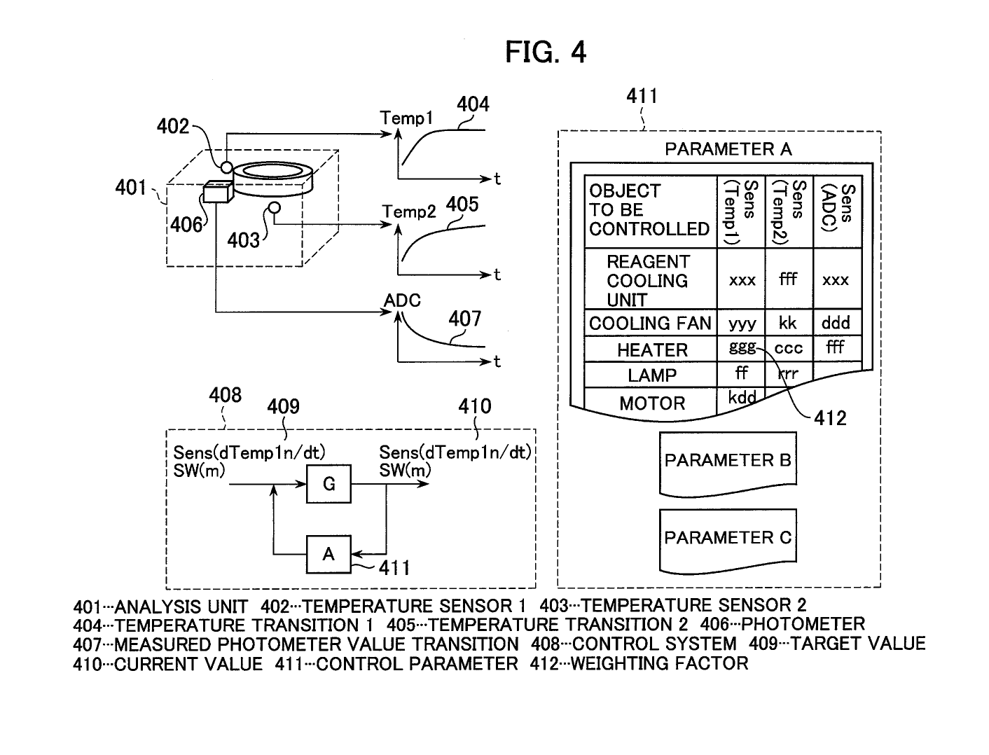

FIG. 4 shows a detailed scheme of power control upon system startup in connection with the present invention. An analysis unit 401 includes a temperature sensor 1 402 and a temperature sensor 2 403 disposed at positions associated with the stability of analysis. Thus positioned, these temperature sensors monitor a temperature transition 1 404 and a temperature transition 2 405. Also, the output value of a photometer 406 is monitored as a measured photometer value transition 407. The stability of the measured photometer value transition 407 is closely associated with the stability of the temperature transition 1 404 and temperature transition 2 405.

A control system 408 performs control in such a manner that, to get the temperature transition 1 404, temperature transition 2 405 and measured photometer value transition 407 converging on stabilized target values 409, current values 410 are brought closer to the target values 409 using a predetermined control parameter 411 relative to the current stability.

The control parameter 411 has its content determined by setting a weighting factor 412 on multiple dimensions so as to determine the degree of weight applied on the respective results of monitoring. This control parameter may have its settings varied depending on the user's preferences, or a plurality of parameters may be prepared beforehand so that the user can select any one of them as desired. This makes it possible to start up the analyzer in the usual startup time or to select a rapid startup or an energy-saving startup.

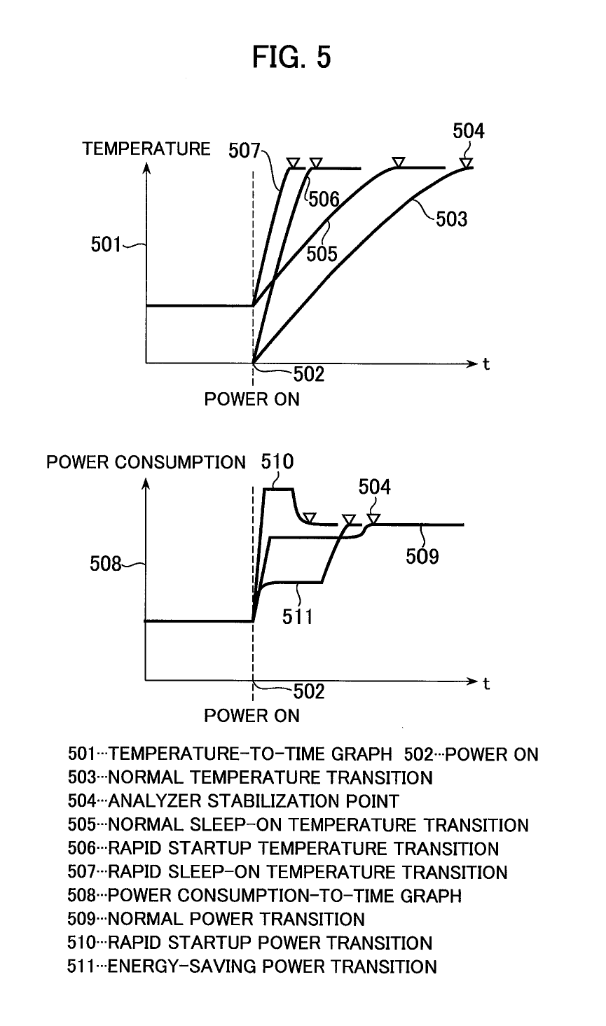

FIG. 5 shows effects of power control according to the present invention. A temperature-to-time graph 501 shows a temperature rise transition from a power-on point 502. A normal temperature transition 503 represents a temperature transition from the power-on point 502 on in accordance with conventional technique. At an analyzer stabilization point 504, the analyzer reaches a stable state in which the analyzer is ready for analysis. A normal sleep-on temperature transition 505 is a temperature transition in effect when solely particular components are kept on prior to the power-on point 502 typically for the purpose of raising the speed of starting up the analyzer. A rapid startup temperature transition 506 is a temperature transition in effect when the objects to be controlled associated with heat generation are controlled by the above-mentioned method so as to shorten the time required to reach the analyzer stabilization point 504. A rapid sleep-on temperature transition 507 is a temperature transition in effect when solely specific components are kept on prior to the power-on point 504 so as to further shorten the startup time.

A power consumption-to-time graph 508 shows a power consumption transition from the power-on point 502. A normal power transition 509 represents a power consumption transition from the power-on point 502 on in accordance with conventional technique. At the analyzer stabilization point 504 indicated, the analyzer reaches a stable state in which the analyzer is ready for analysis. A rapid startup power transition 510 is a power transition in effect when the objects to be controlled are controlled by the above-mentioned method so as to shorten the time required to reach the analyzer stabilization point 504. An energy-saving power transition 511 is a power transition in effect when a tradeoff is made between shortening the time required to reach the analyzer stabilization point 504 and reducing the power consumption upon analyzer startup.

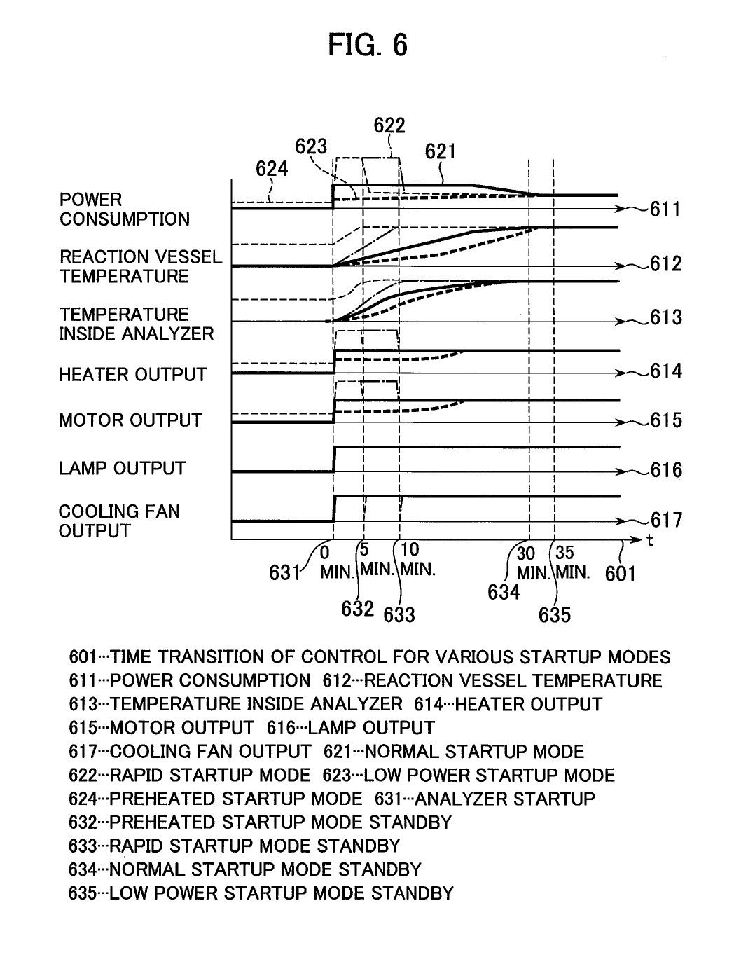

FIG. 6 shows temperature transitions indicative of the stability of object to be controlled in, and power consumption of, an analyzer as a second embodiment of the present invention. A control time transition 601 for various startup modes denotes, along a common time axis, power consumption 611, reaction vessel temperature 612, temperature 613 inside the analyzer, heater output 614, motor output 615, lamp output 616, and cooling fan output 617. The lines in the graph represent typical different startup modes that may be selected for the analyzer to which this invention is applied. The startup modes include normal startup mode 621, rapid startup mode 622, low power startup mode 623, and preheated startup mode 624. And marks along the time axis indicate the time of an analyzer startup 631, as well as the time of preheated startup mode standby 632, time of rapid startup mode standby 633, time of normal startup mode standby 634, and time of low power startup mode standby 635, the times being analysis start-ready times in the different modes.

Normal startup mode 621 indicates a time transition according to the ordinary startup method.

Rapid startup mode 622 is a mode that maximizes the heater output 614, motor output 615 and lamp output 616 as sources contributing to heating, while minimizing or deactivating the cooling fan output 617 contributing to cooling. This allows the reaction vessel temperature 612 and temperature 613 inside the analyzer to rise rapidly for a quicker transition to an analysis-ready state than usual, thereby shortening the waiting time of the user.

Also, power consumption is the largest when the analyzer is started up with a plurality of loads activated usually at the same time. Low power startup mode 623 is a mode that staggers over time the peaks of such loads as heater output, motor output, lamp output, and cooling fan output, thereby avoiding the concentration of power consumption upon startup. This makes it possible to reduce the capacity of a power supply system for the analyzer as well as the capacity of the power supply facility to be prepared by the user, which contributes to lowering initial introduction cost.

Also, preheated startup mode 614 is a mode in which the objects to be controlled are operated to a certain extent while the analyzer is inactive in order to keep the reaction vessel temperature 612 and temperature 613 inside the analyzer fairly high during inactivity for transition to an analysis-ready time (preheated startup mode standby 632) after the analyzer startup 631. This mode permits rapid transition from inactivity to the analysis-ready state and is also effective in handling an emergency request to have a sample analyzed during inactivity such as at night.

According to this invention, as described above, there is provided the function of individually turning on and off the power sources for the components acting as heat and cold sources in the automatic analyzer, as well as the function of storing basic data about the rise and fall of the temperature in the automatic analyzer due to the on/off operations of its components. In this configuration, if it is desired to start up the analyzer from its inactive state to quickly reach the analysis-ready state, the power sources of the components acting as heat sources may be turned on. Where necessary, the supply of energy to the heat sources may be raised to permit a faster transition to a measurement-ready temperature than in normal startup. In this case, such cold sources as the cooling fan and reagent cold storage unit may be kept off to raise the speed of temperature rise in the analyzer while lowering power consumption. Also, feedback control may be performed based on information from a thermometer (or a plurality of thermometers) installed inside the analyzer in such a manner as to control precisely the temperature in the analyzer.

Furthermore, if the analyzer is desired to be started up more quickly, the analyzer may be operated so that some of its components acting as heat sources are kept on even in a standby state in order to maintain the preheated condition.

That is, in a clinical-use automatic analyzer to be started up according to the present invention, the power sources of the loads associated with the temperature in the analyzer can be controlled with regard to each object to be controlled. This makes it possible to freely control the time required to attain a stable temperature unlike with conventional methods and thereby to shorten the time required for the temperature to stabilize. Because the power sources can be controlled per load, it is possible to fine-tune the combination of standby power settings and load power control upon startup in keeping with the user's request. The user is allowed not only to select the degree of energy saving but also to freely select the time it takes for the analyzer to be started up and stabilize.

### DESCRIPTION OF REFERENCE NUMERALS

101, 401 Analysis unit
102 Main SW
103 Operation SW
104 Control unit
105 Mechanism drive unit
106 Reagent cold storage unit
107 Control power source
108 CPU
109 Memory
110 Storage medium
1111/O
112 ADC
113 Operation unit
114 I/F
115 Mechanism power source
116 Drive circuit
117 Sample container
118 Reaction vessel
119 Sample dispensing mechanism
120 Reagent dispensing mechanism
121 Stirring mechanism
122 Multiwavelength photometer
123 Washing mechanism
124 Thermostat
125 Thermostat temperature control unit
201, 301 Objects to be controlled
202 Reagent cold storage unit
203 Cooling fan
204 Heater
205 Lamp
206 Motor
207, 303 Control switch
208, 302 Main power source
209 Transformer
304 Power sensor
305 Power value
306 Heat dissipation
307 Temperature sensor
308 Measured Temperature value
309 CPU
310 Test pattern
402 Temperature sensor 1
403 Temperature sensor 2
404 Temperature transition 1
405 Temperature transition 2
406 Photometer
407 Measured photometer value transition
408 Control system
409 Target value
410 Current value
411 Control parameter
412 Weighting factor
501 Temperature-to-time graph
502 Power ON
503 Normal temperature transition
504 Analyzer stabilization point
505 Normal sleep-on temperature transition
506 Rapid startup temperature transition
507 Rapid sleep-on temperature transition
508 Power consumption-to-time graph
509 Normal power transition
510 Rapid startup power transition
511 Energy-saving power transition
601 Time transition of control for various startup modes
611 Power consumption
612 Reaction vessel temperature
613 Temperature inside analyzer
614 Heater output
615 Motor output
616 Lamp output
617 Cooling fan output
621 Normal startup mode
622 Rapid startup mode
623 Low power startup mode
624 Preheated startup mode
631 Analyzer startup
632 Preheated startup mode standby
633 Rapid startup mode standby
634 Normal startup mode standby
635 Low power startup mode standby

1. An automatic analyzer having a reaction vessel for causing a sample to react with a reagent, and a measurement unit for measuring the reaction in the reaction vessel, the automatic analyzer comprising:
power switches which turn on and off a power sources of at least two of components configuring the automatic analyzer, the components including a heat source for raising the temperature inside the analyzer and a cold source for lowering the temperature inside the analyzer;
selection means which selects any of a plurality of startup modes each corresponding to a temperature rise speed inside the analyzer following an analyzer startup; and
a control mechanism which, in accordance with the startup mode selected by the selection means, controls the on/off operations of the power switch coupled to each of the components.

2. The automatic analyzer according to claim 1, comprising
a function having a thermometer for measuring the temperature inside the analyzer and capable of variably controlling the control mechanism based on measured values of the thermometer.

3. The automatic analyzer according to claim 1, comprising
a storage mechanism which stores temperature change patterns occurring inside the analyzer when the power source of each of the components is turned on and off,
wherein the temperature change pattern inside the analyzer corresponding to the startup mode selected by the selection means is selected from the temperature change patterns stored in the storage mechanism, and
wherein the control mechanism controls the on/off operations of the power source of each of the components in a manner realizing the selected change pattern.

4. The automatic analyzer according to claim 1, comprising
a control mechanism which, in accordance with the startup mode selected by the selection means, performs control to keep some of the components in the power-on state while the analyzer is not started.
